(19) United States
(12) Patent Application Publication
(10) Pub. No.: US 2013/0204435 A1
(43) Pub. Date: Aug. 8, 2013

(54) WEARABLE ROBOT AND TEACHING METHOD OF MOTION USING THE SAME

(71) Applicant: Samsung Electronics Co., Ltd., Suwon-si (KR)

(72) Inventors: Kyung Won Moon, Yongin-si (KR); Young Do Kwon, Yongin-si (KR); Kyung Shik Roh, Seongnam-si (KR)

(73) Assignee: SAMSUNG ELECTRONICS CO., LTD., Suwon-si (KR)

(21) Appl. No.: 13/758,467

(22) Filed: Feb. 4, 2013

(30) Foreign Application Priority Data
Feb. 6, 2012 (KR) 10-2012-0011830

(51) Int. Cl. G06F 17/00

(52) U.S. Cl. CPC G06F 17/00
USPC 700/258; 901/15; 901/46

(57) ABSTRACT

A wearable robot may be worn by a user to record or teach a motion, including a motion such as sign language. The wearable robot includes a mode to record sign language data in a system by a sign language expert wearing the wearable robot and a mode to teach the sign language data recorded in the system to a sign language learner wearing the wearable robot. A user who wishes to learn sign language may easily learn sign language. In particular, a disabled person, who has poor eyesight and is unable to watch a video that teaches sign language, may learn sign language very intuitively using the wearable robot. Further, a user who has normal eyesight may also learn sign language more easily than from using a video which teaches sign language or from a sign language expert.

### CROSS-REFERENCE TO RELATED APPLICATIONS

This application claims the priority benefit of Korean Patent Application No. 10-2012-0011830, filed on Feb. 6, 2012 in the Korean Intellectual Property Office, the disclosure of which is incorporated herein by reference.

### BACKGROUND

1. Field

Embodiments disclosed herein relate to a wearable robot by which a user may learn motions such as sign language, and a teaching method using the same.

2. Description of the Related Art

In general, a robot refers to a mechanical apparatus designed to perform movements resembling human movements using electrical or magnetic actions. Early robots performed hazardous tasks, simple repetitive tasks or tasks requiring great strength on behalf of humans. For example, an industrial robot such as a manipulator or a transfer robot, were designed for the purpose of automated or unmanned systems in the manufacturing field. In more recent developments, research and development of a humanoid robot has been carried out. For example, the humanoid robot may coexist in human working and living spaces, have a human-like appearance, and provide humans with various services.

Recently, a wearable robot that is worn on a human body and allows a joint to move has been developed. The wearable robot has a frame conforming to a body of a user, and includes encoders to read angles of joints, respectively, and motors to move the joints, respectively, as well as a sensor to measure a strength of the user. Accordingly, the wearable robot has a shape to be worn on most joints such as a user's arms, hands, fingers or legs.

After measuring user movement as data, such a wearable robot may perform a power assist function to assist human movements such as providing power to allow the user to easily lift a heavy object or assist in walking training.

Although a conventional wearable robot may perform a power assist function to assist human movement by measuring user movement as data, it does not provide a method to teach human movements (i.e., sign language) to a user.

### SUMMARY

Therefore, it is an aspect of the present invention to provide a wearable robot by which a user may learn motions such as sign language, and a teaching method of a motion using the same.

Additional aspects of the invention will be set forth in part in the description which follows and, in part, will be apparent from the description, or may be learned by practice of the invention.

In accordance with one aspect of the present invention, a wearable robot includes a robot hand worn on a user's hand, a robot arm connected to the robot hand and worn on the user's arm, a plurality of joints provided in the robot hand and the robot arm so as to allow the user's movement, motors to drive the joints, respectively, encoders to measure angles of the joints, respectively, and a controller to record traces of sign language motions by detecting user movement according to the angles of the joints measured by the encoders, and to teach the sign language motions by driving the motors following the recorded traces of the sign language motions.

The robot may further include an input unit to select modes of the wearable robot.

The modes of the wearable robot may include a recording mode to record the traces of the sign language motions and a teaching mode to teach the traces of the sign language motions.

In the recording mode, a trace of a sign language motion of a word implemented by a sign language expert wearing the wearable robot may be acquired as data and recorded.

In the teaching mode, a sign language learner wearing the wearable robot may learn a sign language motion of a word implemented by the wearable robot following a recorded trace of the sign language motion.

The robot may further include a memory to store the traces of the sign language motions of the implemented words during the recording mode or the teaching mode.

The controller, during the recording mode, may control the motors such that they are turned off, and receives signals from the encoders and stores the trace of the sign language of the word performed by the sign language expert in the memory.

The controller, during the teaching mode, may control the motors such that they are turned on, and controls the motors such that they are driven following the trace of the sign language motions stored in the memory, and thereby the sign language learner learns the sign language motion of the word.

The robot may further include a database in which the traces of the sign language motions stored in the memory are recorded by being matched with the corresponding words.

The controller, during the recording mode, may record the traces of the sign language motions stored in the memory in the database along with the corresponding words.

The controller, during the teaching mode, may read the recorded traces of the sign language motions recorded in the database along with the corresponding words and stores the same in the memory.

The controller may include a servo controller to implement the traces of the sign language motions according to a user command input via the input unit, and a main controller to receive the user command from the servo controller and to manage the traces of the sign language motions.

The servo controller and the main controller may transmit data to each other through a communication interface

In accordance with a further aspect of the present invention, a teaching method of a motion using a wearable robot, which includes a robot hand worn on a user's hand, and a robot arm connected to the robot hand and worn on the user's arm, includes performing a recording mode to record traces of sign language motions using the wearable robot, and performing a teaching mode to teach the recorded traces of the sign language motions using the wearable robot.

The user may include a sign language expert or a sign language learner.

The robot may further include a plurality of joints to allow user movement, motors to drive the joints, respectively, and encoders to measure angles of the joints, respectively, and in the recording mode, the motors may be controlled such that they are turned off, and a trace of a sign language motion of a implemented word may be recorded by detecting user movement based on measured angles of the joints by the encoders.

In the recording mode, the trace of the sign language motion of the word may be recorded by being matched with a corresponding word.

In the teaching mode, the motors may be controlled such that they are turned on, and driven following the recorded trace of the sign language such that the user learns the trace of the sign language motion of the word.

In accordance with a further aspect of the present invention, a wearable robot, includes a robot hand, motors to drive joints disposed in the robot hand, encoders to measure angles of the joints, a memory to store traces of motions, and a controller to switch between a first mode and a second mode of the wearable robot based upon a user input. In the first mode the controller records traces of a motion of the wearable robot based on signals of the encoders in the memory, and in the second mode the controller drives motors according to a stored trace of a motion to assist a user wearing the wearable robot to follow the stored trace of the motion.

The controller powers off the motors in response to switching to the first mode, detects the wearable robot has moved to an initial position, and records angles of each joint using the encoders. The controller, in response to switching to the second mode, detects the wearable robot has moved to an initial position, reads a trace of the stored motion from the memory, and drives the motors to assist the user follow the stored trace of the motion

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a diagram showing that a user is wearing a wearable robot according to an embodiment of the present invention;

FIG. 2 is a diagram illustrating an outer appearance of the wearable robot according to the embodiment of the present invention;

FIG. 3 is a block diagram illustrating a motion control configuration of the wearable robot according to the embodiment of the present invention;

FIG. 4 is a flowchart illustrating an algorithm to record motions of sign language using the wearable robot according to the embodiment of the present invention; and

FIG. 5 is a flowchart illustrating an algorithm to teach motions of sign language using the wearable robot according to the embodiment of the present invention.

### DETAILED DESCRIPTION

Reference will now be made in detail to the embodiments of the present invention, examples of which are illustrated in the accompanying drawings, wherein like reference numerals refer to like elements throughout.

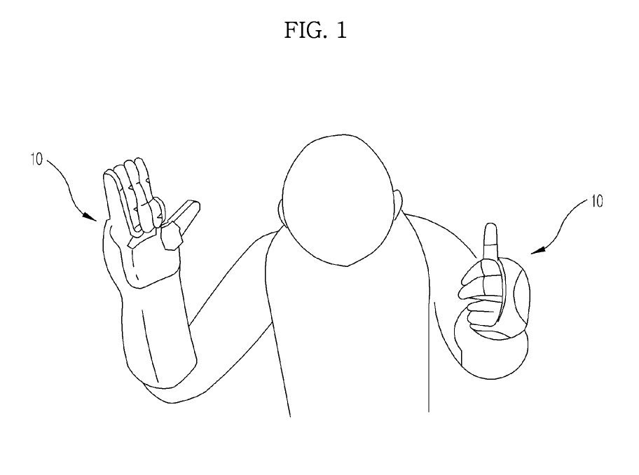

FIG. 1 shows a user wearing a wearable robot according to an embodiment of the present invention.

In FIG. 1, the wearable robot 10 according to the embodiment of the present invention allows a user to learn sign language with the robot worn on either hand. The robot has hardware devices capable of applying motions to either arm of the user and corresponding fingers thereof in order to teach sign language to convey meaning in a visual manner through movement of hands or gestures.

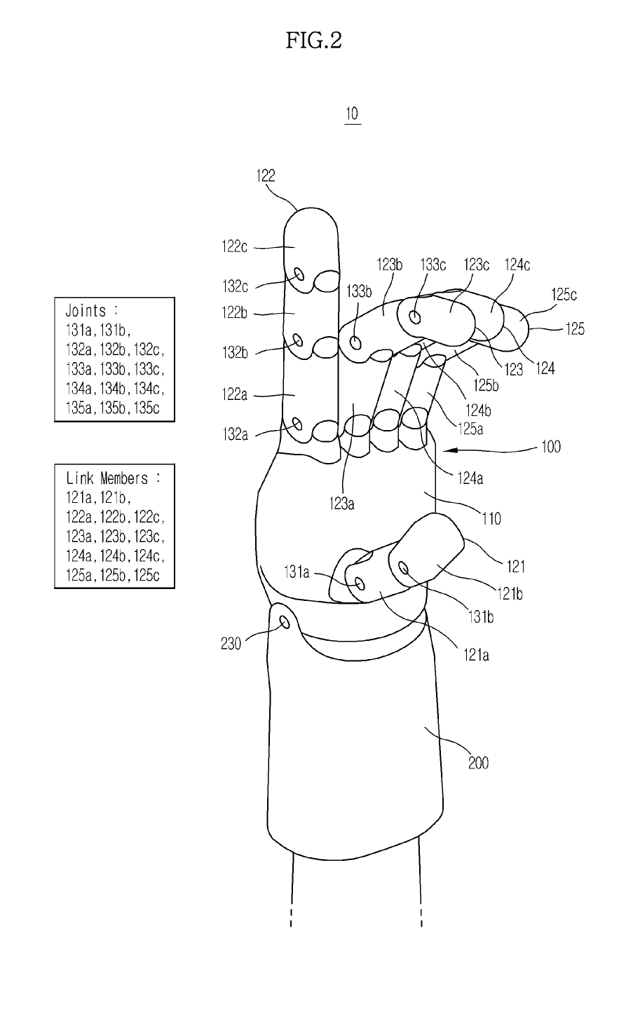

FIG. 2 illustrates an outer appearance of a wearable robot according to the embodiment of the present invention.

In FIG. 2, the wearable robot 10 according to the embodiment of the present invention is an apparatus having a glove shape including a robot hand 100 and a robot arm 200 connected to the robot hand 100. An example will be given in which a user wears the robot on the left hand.

The robot hand 100 may include a palm 110 and a plurality of fingers (for example, five fingers) 120 connected to the palm 110, and the palm 110 is connected to the robot arm 200 with at least one degree of freedom.

The fingers 120 may include first to fifth fingers 121 to 125 which are disposed at a side of the palm 110, and extend outwardly therefrom to bend toward the palm 110. For example at least one of the fingers may oppose one or more other fingers. For example, the first finger 121 may correspond to a thumb and oppose each of fingers 122 to 125. For example, each of the first to fifth fingers may correspond to a thumb, a forefinger, a middle finger, a ring finger and a little finger of a human body, respectively.

The first finger 121 among the plurality of fingers is one into which a human thumb is inserted, is disposed at a side of the palm 110, and extends in a direction to bend toward the palm 110.

The second to fifth fingers among the plurality of fingers are ones into which a forefinger, a middle finger, a ring finger and a little finger are inserted, respectively, and are disposed at a side of the palm 110 and extend in a direction different from that of the first finger 121 to bend toward the palm 110.

In addition, each of the first to fifth fingers 121 to 125 may include a plurality of link members (for example, link members 121a and 121b, 122a to 122c, 123a to 123c, 124a to 124c and 125a to 125c, collectively referred to as link members 121a to 125c). Further, each of the first to fifth fingers 121 to 125 may include a plurality of joints (for example, joints 131a and 131b, 132a to 132c and so on). It is noted that not all joints are shown in FIG. 2 due to the perspective of the drawing. However one of ordinary skill in the art would understand from the drawings that each of the second to fifth fingers include three joints, while the thumb includes two joints. For example, as shown in FIG. 2 the middle finger 133 includes joints 133b and 133c. However, an additional joint 133a (not visible in the drawing) may be disposed in the middle finger in a similar location as that of joint 132a in the index finger. Likewise, joints 134a to 134c may be disposed in the ring finger 134 and joints 135a to 135c may be disposed little finger 135, but are not visible in the drawing. The joints are collectively referred to as joints 131a to 135c. The joints may connect the link members to each other.

The link members 121a to 125c include first link members 121a, 122a, 123a, 124a and 125a, second link members 121b, 122b, 123b, 124b and 125b, and third link members 122c, 123c, 124c and 125c in the named order from the palm 110.

The joints 131a to 135c include first joints 131a, 132a, 133a, 134a, and 135a, second joints 131b, 132b, 133b, 134b, and 135b, and third joints 132c, 133c, 134c, and 135c, in the named order from the palm 110.

The first joints connect the palm 110 to the first link members, the second joints connect the first link members to the second link members, and the third joints connect the second link members to the third link members.

Further, the wearable robot 10 according to the embodiment of the present invention includes the robot arm 200 connected to the robot hand 100. The robot arm 200 is disposed such that it extends in the opposite direction to the direction in which fingers 121 to 125 extend and is connected to the robot hand 100.

The robot arm 200 may include a shoulder joint (not shown), an elbow joint (not shown) and a wrist joint 230 so that parts corresponding to a human shoulder, a human elbow and a human wrist may rotate.

The wrist joint 230 may be movable in the x-axis (roll axis), y-axis (pitch axis) and z-axis (yaw axis) directions.

Accordingly, the robot hand 100 performs various sign language hand gestures to convey meaning by movements of the hand or gestures in cooperation with movement of the robot arm 200.

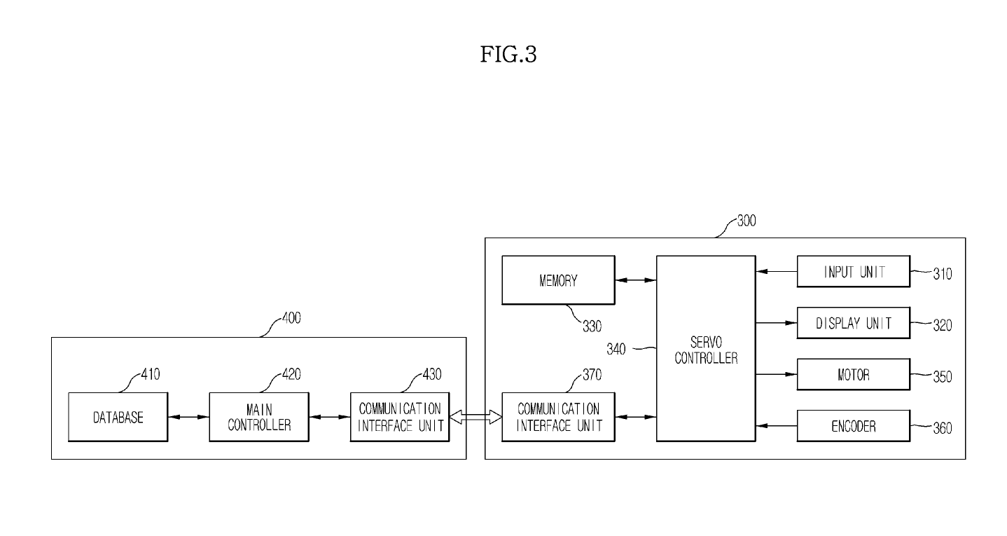

Further, at all of the joints 131a to 135c and 230 of the wearable robot 10, encoders 360 (shown in FIG. 3) to measure angles θ of the joints 131a to 135c and 230, respectively, are provided. Further, at all of the joints 131a to 135c and 230 of the wearable robot 10, motors 350 (for example, transmission devices such as actuators, shown in FIG. 3) to move the joints 131a to 135c and 230, respectively, are provided.

FIG. 3 illustrates a motion control configuration of the wearable robot according to an embodiment of the present invention.

In FIG. 3, a motion control system of the wearable robot 10 according to the embodiment of the present invention may include a robot device 300 to control motions of the wearable robot 10 and a computer device 400 to manage motion data of the wearable robot 10 through a communication interface with the robot device 300.

The robot device 300 may include an input unit 310, a display unit 320, a memory 330, a servo controller 340, motors 350, encoders 360 and a communication interface 370.

The input unit 310 inputs commands to change modes of the wearable robot 10 or to carry out a sign language hand gesture of a certain word to the servo controller 340 according to user operation. The input unit 310 may include one or more keys, buttons, switches, touch pads, keyboards, touch screens, trackballs, or a mouse, and the like, and may include all devices to generate certain input data by an operation such as pushing, pulling, touching, pressing and rotating. The input unit 310 may further include a voice recognition apparatus to recognize the voice of a user as an input command.

The modes of the wearable robot 10 include a recording mode to record sign language data and a teaching mode to teach sign language data.

The recording mode refers to a mode to record a trace of a motion corresponding to a sign language hand gesture (sign language data) in a database. In the recording mode, when a professional sign language interpreter (hereinafter, referred to as a sign language expert) carries out a sign language hand gesture corresponding to a certain word with the wearable robot 10 worn, the trace of the sign language motion of the sign language expert is acquired as data so as to be stored in the database along with the certain word. Here it is noted that the recording mode may be utilized by persons other than experts, and the above-described embodiment is only an example for purposes of explaining the invention. It is apparent that any user may input sign language via a gesture which corresponds to a certain word and a trace of the motion may be acquired as data to be stored in the database along with the certain word.

The teaching mode refers to a mode to teach a trace of a sign language motion (sign language data) recorded in a database. In the teaching mode, when a sign language learner (a user) selects a certain word while wearing the wearable robot 10, the wearable robot 10 moves following a trace of a sign language motion of the certain word recorded in a database. Accordingly, the learner wearing the wearable robot 10 may learn the sign language hand gestures following the trace of the sign language motion by experience. Here it is noted that the teaching mode may be utilized by persons other than a sign language learner, and the above-described embodiment is only an example for purposes of explaining the invention. It is apparent that any user wearing the wearable robot 10 may utilize the teaching mode as described above.

The display unit 320, which is a display device provided in the robot device 300, displays a current state screen of the wearable robot 10 or various types of setting screens according to a display control signal from the servo controller 340. The display device may be implemented as a Liquid Crystal Display (LCD), a Plasma Display Panel (PDP), a cathode ray display (CRT), a light-emitting diode display (LED), an electroluminescent display (ELD), an organic light-emitting diode display (OLED), and the like.

The memory 330 stores a trace of a motion (e.g., sign language data) corresponding to a sign language hand gesture while a mode selected by the input unit 310 (e.g., the recording mode or the teaching mode) is being performed, and may include data storage units such as a read-only memory (ROM) or electrically erasable programmable read-only memory (EEPROM). The memory 330 may also be embodied as non-transitory computer-readable media including magnetic media such as hard disks, floppy disks, and magnetic tape; optical media such as CD ROM disks and DVDs; magneto-optical media such as optical discs; and hardware devices that are specially configured to store and perform program instructions, such as ROM, random access memory (RAM), flash memory (e.g., a USB flash drive), and the like.

Further, the memory 330 stores a trace of a sign language motion of a corresponding word to implement upon receiving signals from the encoders 360 when the mode selected by the input unit 310 is the recording mode.

Further, the memory 330 reads a trace of a sign language motion recorded in association with a corresponding word from the computer device 400 to store when the mode selected by the input unit 310 is the teaching mode.

That is, the memory 330 stores a trace of a sign language motion of a word being currently implemented in performing the recording mode or the teaching mode.

In addition, the memory 330 may store drive information such as control data to control the operation of the wearable robot 10, criterion data used in controlling the operation of the wearable robot 10, operation data generated while the wearable robot 10 is performing a certain motion, and setting data input by the input unit 310 to cause the wearable robot 10 to perform a certain operation.

Although the memory 330 is provided in the robot device 300 in the embodiment of the present invention, embodiments of the present invention are not limited thereto; and, it would be understood by one of ordinary skill in the art that the memory 330 may be provided in the computer device 400.

The servo controller 340 may be a controller to control overall operations of the wearable robot 10 such as mode switching of the wearable robot 10 according to a user command input from the input unit 310 and communication control with the computer device 400. The servo controller 340 stores a trace of sign language in the memory 330 or reads a trace of a sign language motion stored in the memory 330 according to a mode (the recording mode or the teaching mode) selected by the input unit 310.

Further, upon receiving a user command from the input unit 310, the servo controller 340 reads data recorded in the computer device 400 according to the received user command or transfers data so as to be recorded in the computer device 400.

Further, when a mode is selected by the input unit 310, the servo controller 340 changes control modes of the motors 350 and the encoders 360 according to the selected mode (the recording mode or the teaching mode).

For example, if the recording mode is selected by the input unit 310, the servo controller 340 receives a user command from the input unit 310, turns off the control modes of the motors 350, and controls such that only signals from the encoders 360 are read.

If the teaching mode is selected by the input unit 310, the servo controller 340 receives a user command from the input unit 310, turns on the control modes of the motors 350, and controls such that signals of the encoders 360 are read.

A more detailed description will be given below.

When the recording mode is selected by the input unit 310, the servo controller 340 turns the control modes of the motors 350 off and controls such that only signals of the encoders 360 are read. For example, a sign language expert may select the recording mode using the input unit 310 and wear the wearable robot 10. As such, with the motors 350 off, the servo controller 340 receives signals of the encoders 360 to store a trace of a sign language motion (sign language data) of a corresponding word in the memory 330, and records the trace of the sign language motion stored in the memory 330 in association with the corresponding word in a database of the computer device 400 upon completion of the sign language motion.

When the teaching mode is selected by the input unit 310 via a user, the servo controller 340 turns the control modes of the motors 350 on and control such that signals of the encoders 360 are read. For example, a sign language learner may select the teaching mode using the input unit 310, and wear the wearable robot 10. As such, with the motors 350 on (when the motors are under control), the servo controller 340 reads a trace of a sign language motion of a corresponding word from a database of the computer device 400 to store the same in the memory 330. Accordingly, the servo controller 340 drives the motors 350 to follow the trace of the sign language motion stored in the memory 330, so that the sign language learner may learn a sign language gesture by experience following the trace of the sign language motion.

The motors 350 may include actuators that are driven such that each of the joints 131a to 135c and 230 which are provided in the wearable robot 10 may move according to a motor control signal of the servo controller 340.

The motors 350 are driven when the teaching mode is selected by the input unit 310, and each of the joints 131a to 135c and 230 which are provided in the wearable robot 10 may move as appropriate in order to follow the trace of a sign language motion of a word being taught, so that the learner may learn the sign language motion of the word with the wearable robot 10 worn. That is, not all of the motors or joints may move at the same time according to the motor control signal and word being taught.

The encoders 360 measure angles of the joints 131a to 135c and 230 which are, respectively, provided in the wearable robot 10 to transfer the same to the servo controller 340. Signals of the encoders 360 (which include information such as angles of each joint) are measured when the recording mode is selected by the input unit 310. During the recording mode, the motors 350 are off.

Signal measurement by the encoders 360 is performed in such a manner that a sign language motion of a certain word implemented by a sign language expert with the wearable robot 10 worn is read so as to be recorded.

The communication interface unit 370 may be provided in the robot device 300 to perform communication with the computer device 400. Types of the communication interface unit 370 may include embedded and external types.

Further, the communication interface unit 370 may transmit data to the computer device 400 and/or receive data from the computer device 400, via a wired or wireless network. The wireless network may include a ZigBee communication network, a WiFi communication network, a Bluetooth communication network, a mobile communication network, or the like.

In addition, the communication interface unit 370 may cause the display unit 320 to display a message indicating a status of setting information of the robot device under the control of the servo controller 340.

The computer device 400 constituting the motion control system of the wearable robot 10 may include a database 410, a main controller 420 and a communication interface unit 430.

The database 410 records a trace of a motion (sign language data) corresponding to a sign language hand gesture by matching the gesture with a corresponding word. In order to record a trace of a sign language motion along with a corresponding word or implement a trace of a sign language motion recorded along with a corresponding word, the wearable robot 10 is required to move to an initial sign language position of the corresponding word. To this end, initial sign language positions each corresponding to a respective word are recorded in the database 410. The gesture, corresponding word, and initial sign language position, may be stored in the database in the form of a lookup-table. The database 410 may be embodied as non-transitory computer-readable media including magnetic media such as hard disks, floppy disks, and magnetic tape; optical media such as CD ROM disks and DVDs; magneto-optical media such as optical discs; and hardware devices that are specially configured to store and perform program instructions, such as ROM, EEPROM, RAM, flash memory (e.g., a USB flash drive), and the like.

The main controller 420 may refer to a microcomputer to receive a user command input via the input unit 310 from the servo controller 340 and manage sign language motion data. The main controller 420 records a trace of a sign language motion in the database 410 along with a corresponding word or reads a trace of a sign language motion recorded in the database 410 along with a corresponding word, depending on modes selected by the input unit 310.

Further, upon receiving a user command by the input unit 310, the main controller 420 controls the servo controller 340 according to the received user command.

The communication interface unit 430 may be provided in the computer device 400 and performs communication with the robot device 300. Types of the communication interface unit 430 may include embedded and external types.

Further, the communication interface unit 430 may transmit data to the robot device 300 and/or receive data from the robot device 300, via a wired or wireless network. The wireless network may include a ZigBee communication network, a WiFi communication network, a Bluetooth communication network, a mobile communication network, or the like.

Although the servo controller 340 of the robot device 300 and the main controller 420 of the computer device 400 are separately provided such that data may be transmitted and/or received through communication therebetween in the embodiment of the present invention, embodiments of the present invention are not limited thereto. It would be understood by one of ordinary skill in the art that the same effects as those of the embodiment may be obtained by integrating the servo controller 340 of the robot device 300 and the main controller 420 of the computer device 400 into one microcomputer.

Hereinafter, the operational procedure and effects of the above-described wearable robot and a motion teaching method using the same will be described.

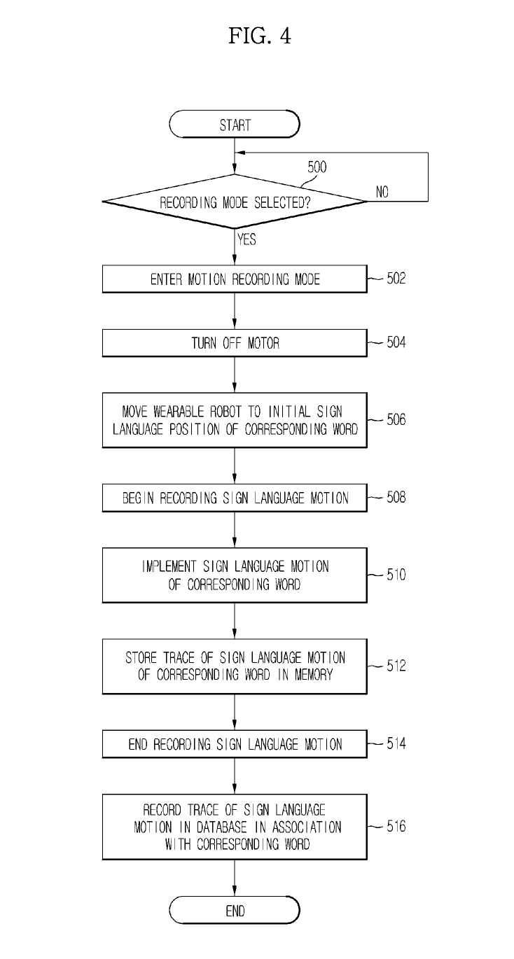

FIG. 4 is a flowchart illustrating an algorithm to record a sign language motion using the wearable robot according to the embodiment of the present invention.

In FIG. 4, a user (for example, a sign language expert) wears the wearable robot 10 and operates the input unit 310 to select a recording mode of the wearable robot 10 (500). At this time, the drive information of the recording mode selected by the user (sign language expert) is input to the servo controller 340 through the input unit 310.

Accordingly, the servo controller 340 causes the wearable robot 10 to enter a motion recording mode according to the drive information input from the input unit 310 (502).

When the wearable robot enters the motion recording mode, the servo controller 340 turns off the control modes of the motors 350, and transfers a user command of the recording mode to the main controller though the communication interface units 370 and 430 in order that only signals of the encoders 360 are read (504).

Accordingly, the servo controller 340 turns off the control modes of the motors 350 so as to allow the user to implement a sign language hand gesture corresponding to a certain word using the wearable robot 10.

As such, in an off state of the motors 350, the user moves the wearable robot 10 to an initial sign language position of a word in order to implement a sign language hand gesture corresponding to the word (506).

When the wearable robot 10 has moved to the initial position of the word, the servo controller 340 starts a recording operation by which a sign language motion may be recorded (508). For example, the servo controller 340 may recognize or detect that the wearable robot 10 has moved to the initial position of the word by receiving an input from the user indicating that the wearable robot 10 is at the initial position.

When the recording operation is started, the user implements a sign language motion of a corresponding word. An angle of each of the joints 131a to 135c and 230 moving in correspondence with the sign language motion implemented by the user is measured at the encoders 360 so as to be input to the servo controller 340 (510).

Accordingly, the servo controller 340 stores an angle of each of the joints 131 a to 135c and 230 measured by the encoders 360 in the memory 330 (512).

By doing so, the trace of the sign language motion implemented by the user is stored in the memory 330. Here, it should be noted that the initial position of the corresponding word may also be stored in the memory 330.

When the user completes the sign language motion of the corresponding word, the servo controller 340 ends the recording operation (514).

When the recording operation ends, the main controller 420 receives the trace of the sign language motion of the corresponding word stored in the memory 330 through the communication interface units 370 and 430 to store the same in the database 410 by matching the corresponding word with the trace of the sign language motion (516).

As such, recording of the trace of the sign language motion corresponding to the corresponding word is completed by recording the trace of the sign language motion in the database 410 in association with the corresponding word.

Here, it should be noted that the word may pre-exist in the database 410 of the computing device 400 or the user may enter the corresponding word via the input unit 310 at any time. For example, the corresponding word may be entered just prior to entering the recording mode, after the recording mode is entered, before the sign language motion is recorded, after the sign language motion recorded, or after the trace of the sign language motion is stored in the database 410. Further, the corresponding word may be stored by the servo controller 340 into the database 410 along with the trace of the sign language motion. Further, the initial sign language position information of the corresponding word may be stored by the servo controller 340 into the database 410 at various points in time.

As one example, a user may desire to record the word “heart.” The user may select the recording mode and input the word “heart” using the input unit 310 (e.g., via a voice input or manual input). Alternatively, the user may select the word “heart” from the database 410 of the computer device 400. The servo controller 340 may turn the motors 350 off. The user may then move the wearable robot to an initial position of the word. The servo controller 340 may detect or recognize that the wearable robot 10 has moved to an initial position of the word and start a recording operation to record the sign language motion for the word “heart.” As the user makes the sign language motion of the word “heart,” encoders 360 measure angles of each of the joints 131a to 135c and 230, and the servo controller 340 stores the measured angles in the memory 330. When the sign language motion for the word “heart” is complete, the servo controller 340 ends the operation. By way of example, the servo controller 340 may determine that the sign language motion is complete by a lack of motion after a predetermined amount of time, or by way of the user providing an input indicating the motion is complete. After the recording operation is terminated, the main controller 420 receives the trace of the sign language motion corresponding to the word “heart,” and stores the trace in the database 410. The trace is associated with the word “heart,” which may be prestored in the database previously, may be added by the user, or the word may be received via the robot device 300. Likewise, data associated with the initial position of the wearable robot for the word “heart,” may be stored in the database 410 from the robot device 300. In another embodiment, the trace may be repeated and recorded a predetermined number of times corresponding to a setting input by the user through the input unit 310. Further, more than one word may be entered into the input unit 310, and the input may include a plurality of words, sentences, and the like. The servo controller 340 may, for example, at one time store the traces of the sign language motions corresponding to the plurality of words or sentences, etc., into the memory 330 and store the same in the database 410 in a single operation.

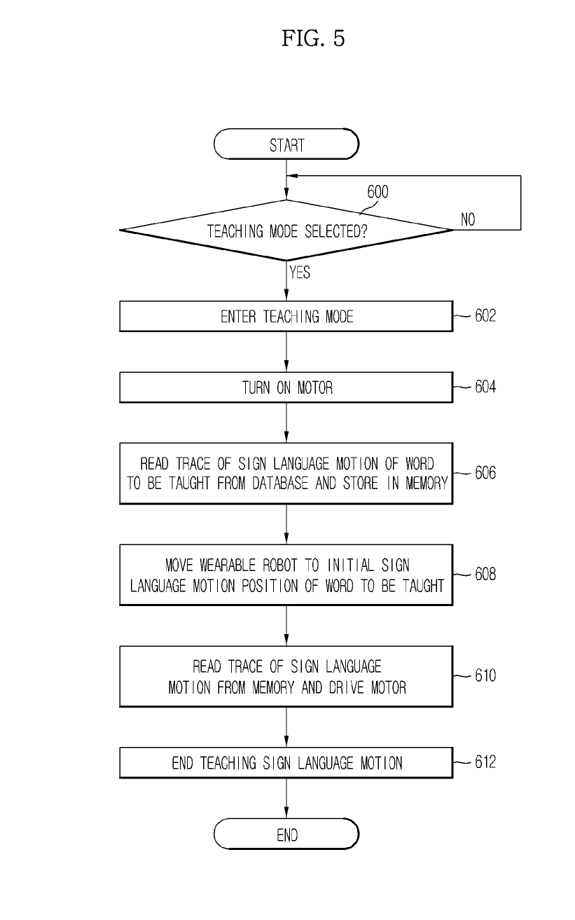

FIG. 5 is a flowchart illustrating an algorithm to teach a sign language motion using the wearable robot according to the embodiment of the present invention.

In FIG. 5, a user (e.g., a sign language learner) wears the wearable robot 10 and operates the input unit 310 to select a teaching mode of the wearable robot 10 (600). At this time, drive information of the teaching mode selected by the user is input to the servo controller 340 through the input unit 310.

Then, the servo controller 340 causes the wearable robot to enter a motion teaching mode according to the drive information input from the input unit 310 (602).

When the wearable robot 10 enters the motion teaching mode, the servo controller 340 turns on the control modes of the motors 350 and transfers a user command of the teaching mode to the main controller 420 through the communication interface units 370 and 430 so that signals of the encoders 360 are read (604).

Accordingly, the servo controller 340 turns the control modes of the motors 350 on and allows a user to implement a sign language hand gesture corresponding to a word to be taught using the wearable robot 10.

To this end, the main controller 420 reads a trace of the sign language motion of the word to be taught from the database 410 to store in the memory 330 of the robot device 300 via the servo controller 340 and through the communication interface units 370 and 430 (606).

As such, after the process of reading the trace of the sign language motion of the word to learn from the database 410 in an on state of the motors 350 is completed, the wearable robot 10 is moved to an initial sign language position of the word to be taught in order to implement the sign language hand gestures corresponding to the word to learn (608).

When the wearable robot 10 has moved to the initial sign language position of the word to learn, the servo controller 340 reads the trace of the sign language motion from the memory 330 and drives the motors 350 following the trace of the sign language motion of the word to be taught (610).

When each of the joints 131a to 135c and 230 moves by driving the motors 350, the user may learn the sign language hand gestures of the word by experience with the wearable robot 10 being worn.

As such, teaching of the trace of the sign language motion corresponding to the corresponding word is completed by driving the motors 350 following the trace of the sign language motion of the word recorded in the database 410 to allow each of the joints 131a to 135c and 230 to move (612).

As one example, a user may desire to learn how to sign the word “heart.” The user may select the teaching mode and input the word “heart” using the input unit 310 (e.g., via a voice input or manual input). Alternatively, the user may select the word “heart” from the database 410 of the computer device 400. The servo controller 340 may turn the motors 350 on and control such that signals of the encoders 360 are read. The servo controller 340 may read a trace of a sign language motion corresponding to the word “heart” from the database 410 of the computer device 400 to store the trace in the memory 330. After reading the trace, the wearable robot 10 may be moved to an initial sign language position of the word “heart” in order to implement the sign language hand gestures corresponding to the word “heart.” The servo controller 340 reads the trace of the sign language motion from the memory 330 and drives the motors 350 following the trace of the sign language motion of the word “heart” to assist the user in learning the hand gestures of the word until the teaching of the trace of the sign language motion corresponding to the word “heart” is completed. In another embodiment, the trace may be repeated a predetermined number of times corresponding to a setting input by the user through the input unit 310. Further, more than one word may be entered into the input unit 310, and the input may include a plurality of words, sentences, and the like. The servo controller 340 may, for example, at one time read the traces of the sign language motions corresponding to the plurality of words or sentences, etc., from the database and store the same in the memory 330 in a single operation.

Although the example embodiments of the present invention in which the wearable robot 10 is used to teach sign language has been described, embodiments of the present invention are not limited thereto. It would be understood by one of ordinary skill in the art that the same effects as those of the above-described embodiments may be obtained by using the wearable robot 10 to teach sport motions such as baseball, boxing, golf, and the like. For example the wearable robot 10 may be used to train a user to learn a musical instrument, to simulate performing a surgery or simulate operating a vehicle such as a plane, or to learn to type. As one example, a user (e.g., a piano virtuoso) wearing the wearable glove may record finger, hand, wrist, and/or arm movements while playing a piano concerto in the above-described recording mode. A user (e.g., a piano student) may use the teaching mode to learn the piano concerto while wearing one or more wearable robots to assist the student in movement of the student's fingers, hands, wrists, and/or arms. As one of ordinary skill in the art would understand, more than one wearable robot may be worn by a user, and each wearable robot may communicate with the same or different computer devices.

By way of example, the word “help” in American Sign Language may be signed by closing the right hand with the thumb extended vertically upward, placing the right hand in the palm of the left hand (the palm facing upward), and then lifting both hands upward together. It would be understood by one of ordinary skill in the art that a user wearing a wearable robot on each hand may record or be taught the above-mentioned movements using the motion control system described herein.

As mentioned above, one of ordinary skill in the art would understand that many gestures (for example many signs utilized in sign language) require movement of both hands. Therefore, the example embodiments of the present invention in which motors, joints, and angles applicable to one wearable robot worn on one hand, are likewise applicable to two or more wearable robots which may be worn on two hands or on other parts of the body. For example, one servo controller 340 may control overall operations of two wearable robots worn by a user to control motors and joints of each wearable robot. Alternatively, one computer device 400 may be used to manage motion data of two or more wearable robots.

As is apparent from the above description, according to the wearable robot and the teaching method of a motion using the same according to embodiments of the present invention, a mode to record sign language data in a system by a user (e.g., a sign language expert) wearing the wearable robot and a mode to teach the sign language data recorded in the system to a sign language learner wearing the wearable robot are provided, so that a user who wishes to learn sign language may easily learn sign language. In particular, it may be possible that a disabled person, who has poor eyesight and may be unable to watch a video that teaches sign language, may learn sign language very intuitively with the wearable robot being worn. Further, a user who has normal eyesight may also learn sign language more easily than from using a video to learn sign language or from a sign language expert.

In the above-described example embodiments, some of the components constituting the wearable glove, robot device, and/or computer device may be realized by a kind of module. The module may include software components or hardware components, such as a field programmable gate array (FPGA) or an application specific integrated circuit (ASIC), to perform a specific function. However, the module is not limited to software or hardware. The module may be configured to be present in an addressable storage medium or to execute one or more processors.

The apparatus and methods for controlling the wearable glove, robot device, and/or computer device according to the above-described example embodiments may use one or more processors, which may include a microprocessor, central processing unit (CPU), digital signal processor (DSP), or application-specific integrated circuit (ASIC), as well as portions or combinations of these and other processing devices.

The terms “module”, and “unit,” as used herein, may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Methods or algorithms for controlling the wearable glove, robot device, and/or computer device according to the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa. Some or all of the operations performed in the methods for controlling the wearable glove, robot device, and/or computer device, according to the above-described example embodiments may be performed over a wired or wireless network. In addition, for example, a processing element may include a processor or a computer processor. The processing element may be distributed and/or included in a device.

Each block of the flowchart illustrations may represent a unit, module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Although a few example embodiments of the present invention have been shown and described, it would be appreciated by those skilled in the art that changes may be made to these embodiments without departing from the principles and spirit of the invention, the scope of which is defined in the claims and their equivalents.

What is claimed is:

1. A wearable robot to be worn by a user, comprising:
a robot hand; a robot arm connected to the robot hand; a plurality of joints provided in the robot hand and the robot arm; motors to drive the joints, respectively;
encoders to measure angles of the joints, respectively; and
a controller to record traces of motions by detecting user movement of the wearable robot worn by the user, according to the angles of the joints measured by the encoders, and to teach the motions by driving the motors following the recorded traces of the motions.

2. The robot according to claim 1, further comprising an input unit to select modes of the wearable robot.

3. The robot according to claim 2, wherein the modes of the wearable robot include a recording mode to record the traces of the motions and a teaching mode to teach the traces of the motions.

4. The robot according to claim 3, wherein, in the recording mode, a trace of a sign language motion of a word implemented by a user wearing the wearable robot is acquired as data and recorded.

5. The robot according to claim 3, wherein, in the teaching mode, a user wearing the wearable robot learns a sign language motion of a word implemented by the wearable robot following a recorded trace of the sign language motion.

6. The robot according to claim 4, further comprising a memory to store the traces of the sign language motions of the implemented words during the recording mode.

7. The robot according to claim 6, wherein the controller, during the recording mode, controls the motors such that they are turned off, and receives signals from the encoders and stores the trace of the sign language of the word performed by the user in the memory.

8. The robot according to claim 6, wherein the controller, during the recording mode, records the traces of the sign language motions stored in the memory in a database along with the corresponding words.

9. The robot according to claim 5, further comprising a memory to store the traces of the sign language motions of the implemented words during the teaching mode.

10. The robot according to claim 9, wherein the controller, during the teaching mode, controls the motors such that they are turned on, and controls the motors such that they are driven following the trace of the sign language motions stored in the memory, and to assist the user in learning the sign language motion of the word.

11. The robot according to claim 9, further comprising a database in which the traces of the sign language motions stored in the memory are recorded by being matched with the corresponding words.

12. The robot according to claim 10, wherein the controller, during the teaching mode, reads the recorded traces of the sign language motions recorded in the database along with the corresponding words and stores the same in the memory.

13. The robot according to claim 1, wherein the controller includes a servo controller to implement the traces of motions according to a user command input via an input unit, and a main controller to receive the user command from the servo controller and to manage the traces of the motions.

14. The robot according to claim 13, wherein the servo controller and the main controller transmit data to each other through a communication interface.

15. A method for recording and teaching a motion using a wearable robot worn by a user, the wearable robot including a robot hand and a robot arm connected to the robot hand, the method comprising:
performing a recording mode to record traces of motions using the wearable robot; and
performing a teaching mode to teach the recorded traces of the motions using the wearable robot.

16. The method according to claim 15, wherein, in the recording mode, the method further comprises acquiring data from a trace of a sign language motion of a word implemented by the user wearing the wearable robot, and recording the data in a memory.

17. The method according to claim 15, wherein, in the teaching mode, the method further comprises acquiring data corresponding to a trace of a sign language motion of a word desired to be learned by a sign language learner wearing the wearable robot, the data being recorded in a database, and storing the trace in a memory of the wearable robot, and the sign language learner learns a sign language motion of the word by following the trace of the sign language motion.

18. The method according to claim 15, wherein the robot further includes a plurality of joints to allow user movement, motors to drive the joints, respectively, and encoders to measure angles of the joints, respectively, and
in the recording mode, the method further comprises:
controlling the motors such that they are turned off, and
recording a trace of a sign language motion of an implemented word by detecting user movement based on measured angles of the joints by the encoders.

19. The method according to claim 18, wherein the recording further comprises matching the trace of the sign language motion of the implemented word with a corresponding word.

20. The method according to claim 18, wherein, in the teaching mode, the method further comprises:
controlling the motors such that they are turned on and driven following the recorded trace of the sign language motion, to assist the user in learning the trace of the sign language motion of the word.
